(19) United States
(12) Patent Application Publication
(10) Pub. No.: US 2016/0037729 A1
(43) Pub. Date: Feb. 11, 2016

(54) Floral Preservation Apparatus

(71) Applicant: Sudhir Pandit, Amity, AR (US)

(72) Inventor: Sudhir Pandit, Amity, AR (US)

(21) Appl. No.: 14/456,219

(22) Filed: Aug. 11, 2014

(51) Int. Cl. A01G 5/06

(52) U.S. Cl. CPC A01G 5/06

(57) ABSTRACT

A floral preservation apparatus operable to prolong the freshness of cut flowers utilizing a pressurized container to facilitate the introduction of fluid into cut flower stalks. The floral preservation apparatus includes a container having an interior volume with an opening providing access thereto. An insert is releasably secured into the container through the opening. Disposed across the insert is a sealing membrane having a plurality of downwardly extending nipples. The sealing membrane and insert provide a hermetic seal of the interior volume. Cut flower stalks are journaled through the nipples and collapsible walls of the nipples bias against the cut flower stalks providing a hermetic seal therearound. A pressure bulb is operably attached to the container so as to provide pressurization to the interior volume of the container.

### FIELD OF THE INVENTION

The present invention relates generally to floral retaining vessels, more specifically but not by way of limitation, a floral vase that is operable to provide a portion thereof that has a pressure greater than that of atmospheric pressure wherein the vessel facilitates fluid being transferred to a cut flower stalk in order to increase the life and freshness of the flowers being retained in the vase.

### BACKGROUND

Cut flowers and decorative plants are very common for either a special occasion such as an anniversary or for use as display in numerous commercial and residential environments. Floral arrangements are typically either presented in a bundle with wrapping or can be presented in a vase that functions to retain the floral arrangement while further being able to provide water to the cut ends of the stalks of the floral arrangement. Numerous styles of conventional vases are utilized to display cut floral arrangements ad it is common practice to at least partially fill the vase with water so as to immerse the cut ends of the stalks therein.

One problem with cut floral arrangements is the life expectancy of the cut flowers is relatively short. An exemplary floral arrangement of roses or similar flower will typically only last five to seven days in a conventional vase with water. These arrangements can often be quite expensive and it is desirable to many that the arrangement is able to be displayed for a longer period of time. Existing technology will apply a preservative to either the floral arrangement itself or as an additive to the water in the vase. This technique has shown to have only minimal success with results of extending the life of the cut floral arrangement by another day or two. Additionally, these chemicals require an additional cost and may not be suited for various environments.

Accordingly there is a need for a floral vase that is operable to receive, retain and display a cut floral arrangement that functions to substantially increase the life and freshness of the cut floral arrangement without the need for chemical additives.

### SUMMARY OF THE INVENTION

It is the object of the present invention to provide a floral preservation vessel that is operable to receive and retain a cut floral arrangement wherein the vessel includes an interior volume of suitable size to accommodate the cut stalk ends of the floral arrangement.

Another object of the present invention is to provide a floral preservation vase operable to extend the life and freshness of a cut floral arrangement disposed therein that includes a sealing member across the opening of the floral preservation vase.

A further object of the present invention is to provide a floral preservation vessel wherein the sealing member is hermetically isolates the interior volume of the floral preservation vessel.

Yet another object of the present invention is to provide a floral preservation vessel operable to extend the life and freshness of a cut floral arrangement wherein the sealing member is positioned proximate the opening of the floral preservation vessel with a support ring.

An additional object of the present invention is to provide a floral preservation vessel operable to extend the life and freshness of a cut floral arrangement wherein the sealing member further includes plurality of projections integrally formed therewith wherein the projections extend downward into the interior volume of the floral preservation vessel.

Still a further object of the present invention is to provide a floral preservation vessel wherein the plurality of projections further include a central aperture and passage facilitating the receipt of a cut flower stalk.

A further object of the present invention is to provide a floral preservation vessel that includes a pressure pump atmospherically coupled to the interior volume of the floral preservation vessel.

Yet another object of the present invention is to provide a floral preservation vessel operable to extend the life and freshness of a cut floral arrangement that further includes a support grid proximate the sealing member so as to provide support for the cut floral arrangement disposed within the floral preservation vessel.

A further object of the present invention is to provide a floral preservation vessel operable to extend the life of a cut floral arrangement that includes a pressure monitor functioning to monitor the pressure of the interior volume of the floral preservation vessel.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 is a top perspective view of the sealing membrane, gauge and pressure bulb of the present invention; and

FIG. 2 is a perspective view of the support grid of the present invention; and

FIG. 3 is a view of the ring insert and sealing collar of the present invention; and

FIG. 4 is a perspective view of the vessel of the present invention; and

FIG. 5 is a side diagrammatic view of the present invention.

### DETAILED DESCRIPTION

Referring now to the drawings submitted herewith, wherein various elements depicted therein are not necessarily drawn to scale and wherein through the views and figures like elements are referenced with identical reference numerals, there is illustrated a floral preservation apparatus 100 constructed according to the principles of the present invention.

Referring in particular to FIG. 4 herein, the floral preservation vessel 100 includes a container 10. The container 10 includes a wall 50 integrally formed with a bottom 52 having an opening 54 providing access to the interior volume thereof. The container 10 is manufactured from a suitable durable material such as but not limited to plastic and is suitable for receiving and retaining fluids such as but not limited to water. The container 10 is of suitable size in order to accommodate a plurality of cut flower stalks or similar items so as to provide storage and display thereof. While the container 10 is illustrated herein as being a specific shape and having one wall 50, it is contemplated within the scope of the present invention that the container 10 could be formed with more than one wall and further be manufactured in numerous different sizes and shapes.

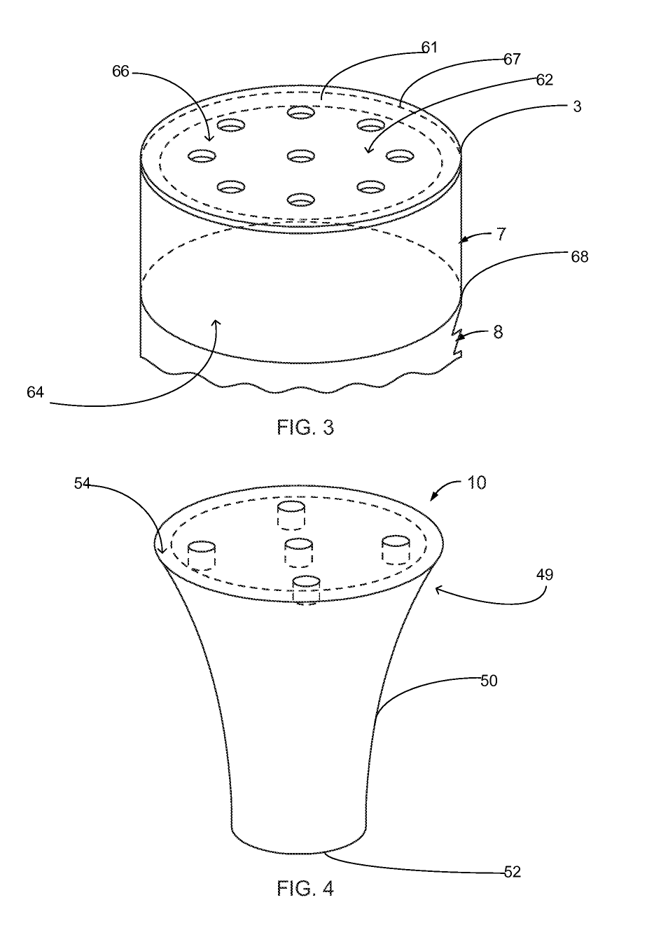

As shown in particular in FIG. 3, the floral preservation apparatus 100 further includes a ring insert 7. The ring insert 7 is manufactured from a suitable durable material such as but not limited to plastic. The ring insert 7 is mateably shaped so as to be placed within the opening 54 of the container 10 and subsequently inserted into the interior volume thereof. While the ring insert 7 is illustrated herein as being annular in shape, the annular construction illustrated functions to mateably couple with the opening 54 and upper portion 49 of the container 10. It is contemplated within the scope of the present invention that the ring insert 7 is constructed to be of mateable shape with the opening 54 and upper portion 49 of the container 10 so as to be inserted therein. Those skilled in the art will recognize that the ring insert 7 could be constructed in numerous different shapes in order to accomplish the desired functionality as described herein. The ring insert 7 includes a wall 61 that is contiguous and is operable to define an upper opening 62 and a lower opening 64 having a passage 66 intermediate thereto. Secured to the lower edge 68 of wall 61 by suitable techniques is a sealing collar 8. The sealing collar 8 is manufactured from a suitable durable material such as but not limited to plastic or rubber and is operable to provide a substantially hermetic seal against the interior surface 70 of the wall 50 of the container 10. As further discussed herein, the hermetic isolation of the interior volume 48 of the container 10 is required in order to pressurize the interior volume 48.

A sealing membrane 3 is disposed across the upper opening 62. The sealing membrane 3 is manufactured from a resilient material such as but not limited to rubber latex and is operable to atmospherically isolate the interior volume 48 of the container 10. The sealing membrane 3 is secured to the wall 61 utilizing suitable durable techniques. While in the disclosed embodiment the sealing membrane 3 is secured to the top portion 67 of the wall 61, it is contemplated that the sealing membrane 3 could be secured to outer surface 71 of the wall 61 or to another suitable location thereon. The sealing membrane 3 is manufactured in a shape that is of similar shape to the upper opening 62. As previously discussed herein, the ring insert 7 could be manufactured in numerous different shapes so as to mateable couple with containers 10 of similar shapes, and as such the same is contemplated for the sealing membrane 3 wherein the sealing membrane is of similar shape as the upper opening 62 of the ring insert 7 and is sealable secured to the wall 61 thereof.

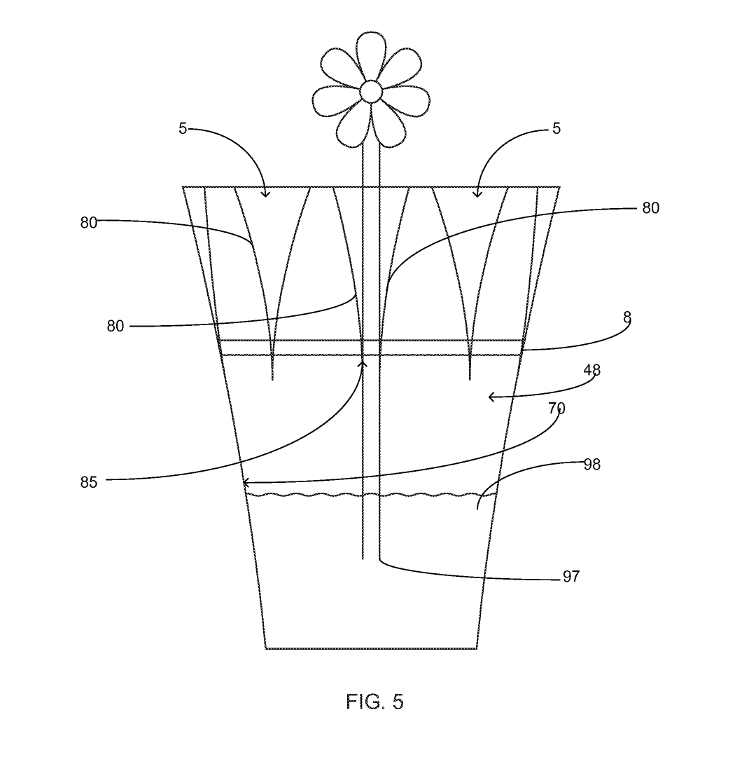

Integrally formed with the sealing membrane 3 are a plurality of nipples 4. The nipples 4 function to receive a cut stalk 99 of an exemplary flower 1 therethrough wherein the cut stalk 99 is placed within the container 10 such that end 97 is disposed in fluid 98. The nipples 4 include opening 5 that is generally annular in shape and wall 80. The wall 80 is operable to bias against the cut stalk 99 and provide a hermetic seal therearound. As shown in FIG. 5, the wall 80 of the nipple 4 protrudes downward and is biased against cut stalk 99 subsequent the cut stalk 99 being journaled through the opening 5. The biasing of the wall 80 against the cut stalk 99 functions to provide the hermetic seal needed in order to pressurize the interior volume 48 of the container 10 as discussed herein. Distal to opening 5 is second opening 85. The second opening 85 permits the cut stalk 99 to be journaled completely through the nipple 4. The wall 80 of the nipple 4 is constructed of sufficient length and material wherein when a cut stalk 99 is not journaled through the nipple 4 the wall 80 collapses on itself so as to provide a substantial sealing of the second opening 85 in order to inhibit any loss of pressurization of the interior volume 48. It is contemplated within the scope of the present invention that the sealing membrane 3 could have as few as one nipple 4 or a plurality of nipples 4 in order to receive a cut stalk 99 of an exemplary flower 1 therethrough.

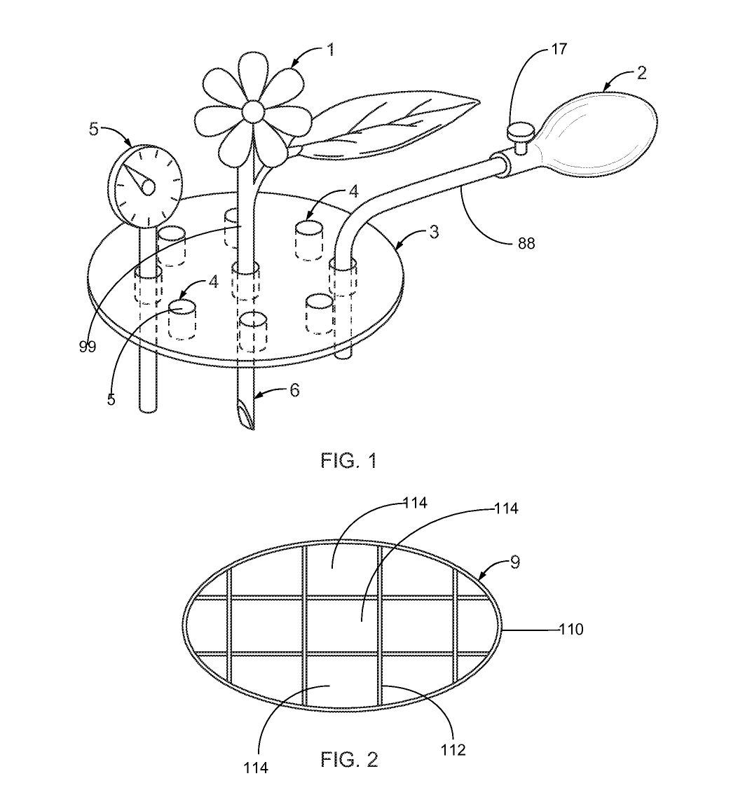

Illustrated herein in FIG. 1, is a pressure bulb 2. The pressure bulb 2 is operably coupled to the interior volume 48 of the container 10 via tube 88. The pressure bulb 2 is a conventional collapsible pressure bulb having a valve 17. Tube 88 is a conventional hollow tube that allows air from the pressure bulb 2 to be pumped into the interior volume 48 of the container 10. Tube 88 is journaled through a nipple 4 so as to extend beyond the second opening 85. The pressure bulb 2 facilitates the pressurizing of the interior volume 48 of container 10. Subsequent at least one cut stalk 99 being journaled through the sealing membrane 3, in order to prolong the life of the exemplary flower, the interior volume 48 is pressurized so as to assist in the transportation of the fluid 98 into the cut stalk 99. While no particular pressure is required, good results have been achieved utilizing a pressure between 1 psi and 10 psi. A conventional pressure gauge 5 is operably coupled to the sealing membrane 3 and functions to provide measurement of the pressure within the interior volume 48. It is contemplated within the scope of the present invention that the pressure gauge 5 could be analog or digital.

Illustrated in FIG. 2 is a support grid 9. The support grid 9 functions to provide additional structural support for a cut stalk 99 subsequent to being journaled through a nipple 4. The support grid 9, once installed, is disposed across the upper opening 62 of the ring insert 7. The support grid 9 is manufactured from a suitable durable material such as but not limited to metal or plastic wire. Support grid 9 includes outer ring 110 that is formed in a similar shape as ring insert 7 so as to mateable couple therewith utilizing suitable durable techniques. Connected to the outer ring 110 are a plurality of cross members 112 that are operable to form apertures 114. The apertures 114 function to receive the cut stalk 99 and provide vertical structural support therefore. It is contemplated within the scope of the present invention that the apertures 114 could be formed utilizing a plurality of cross members 112 so as each aperture 114 is aligned with a nipple 4 and provide support for one cut stalk 99. Alternatively, the apertures 114 could be sized so as to have several nipples 4 superposed thereto and provide structural support for a plurality of cut stalks 99.

Referring to the drawings herein, a description of the operation of the floral preservation apparatus 100 is as follows. In use, a user will at least partially fill the interior volume 48 of the container 10 with a fluid such as but not limited to water. The ring insert 7 is inserted into the opening 54 and pushed downward into the interior volume 48. The sealing collar 8 engages the interior surface 70 providing a frictionally maintained hermetic seal therebetween. At least one exemplary flower 1 having a cut stalk 99 is journaled through a nipple 4 wherein the wall 80 of the nipple 4 maintains a bias against the cut stalk 99 creating a hermetic seal therearound. The user will then pressurize the interior volume 48 using the pressure bulb 2 so as to provide a positive pressure within the interior volume 48 facilitating the improved transfer of the fluid 98 into the exemplary flower 1 and thus increasing the freshness and life thereof.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. A floral preservation apparatus comprising:
a container, said container having at least one wall and a bottom integrally formed to create an interior volume, said container having an opening opposite said bottom
an insert, said insert being formed in a mateable shape to said opening of said container, said insert having a contiguous wall with a first opening and a second opening, said insert having a passage intermediate said first opening and said second opening;
a sealing membrane, said sealing membrane manufactured from a resilient material, said sealing membrane disposed across said first opening of said insert,
at least one nipple, said nipple being integrally formed with said sealing membrane, said nipple having a first opening and a second opening, said nipple having a wall intermediate said first opening and said second opening; and
wherein said wall of said nipple is operable to be biased against a cut flower stalk that has been journaled through said nipple providing a hermetic seal therearound.

2. The floral preservation apparatus as recited in claim 1, and further including a sealing collar, said sealing collar formed with said insert, said sealing collar operable to provide a substantially hermetic seal between said container and said insert.

3. The floral preservation apparatus as recited in claim 2, and further including a pressure bulb, said pressure bulb operably coupled to the interior volume of said container, said pressure bulb operable to increase the pressure of the interior volume.

4. The floral preservation apparatus as recited in claim 3, wherein said at least one nipple extend downward into said interior volume and wherein said wall of said at least one nipple is collapsible against itself.

5. The floral preservation apparatus as recited in claim 4, and further including a support grid, said support grid disposed across said opening of said insert, said support grid having a plurality of cross members forming apertures operable to provide vertical structural support for a cut flower stalk.

6. The floral preservation apparatus as recited in claim 5, an air tube, said air tube operably coupled to said pressure bulb and the interior volume of said container.

7. The floral preservation apparatus as recited in claim 6, and further including a pressure gauge, said pressure gauge operable to provide measurement of the pressure of the interior volume of the container.

8. An apparatus operable to display cut flowers wherein the apparatus functions to prolong the freshness of the cut flowers disposed therein comprising:
a container, said container having at least one wall and a bottom integrally formed to create an interior volume, said container having an opening opposite said bottom, said container having an upper portion and a lower portion, said container being of sufficient height to receive and support a plurality of cut flowers;
an insert, said insert having a contiguous wall forming an upper opening and a lower opening, said insert being of similar shape as the upper portion of said container, said insert having an upper edge and a lower edge;
a sealing membrane, said sealing membrane being manufactured from a resilient material, said sealing membrane disposed across said upper opening of said insert, said sealing membrane hermetically sealed to the upper edge of the contiguous wall of said insert;
a plurality of nipples, said plurality of nipples integrally formed with said sealing membrane, said plurality of nipples extending downward into the interior volume of said container, and
wherein the plurality of nipples are operable to receive a cut flower stalk therethrough and subsequently bias thereagainst so as to provide a hermetic seal therearound in order to maintain a positive pressure within the interior volume.

9. The apparatus as recited in claim 8, wherein said plurality of nipples include a wall, said wall being contiguous, said wall defining a passage through said nipple, said wall being collapsible on itself.

10. The apparatus as recited in claim 9, and further including a sealing collar, said sealing collar being secured to said lower edge of said insert, said sealing collar extending completely around said insert, said sealing collar operable to engage an interior surface of said at least one wall of said container so as to provide a hermetic seal.

11. The apparatus as recited in claim 10, and further including a support grid, said support grid having an outer frame, said support grid having a plurality of cross members within said outer frame, said support grid operable to provide structural support for cut flower stalks.

12. The apparatus as recited in claim 11, and further including a pressure bulb, said pressure bulb operably coupled to the interior volume of said container via a tube, said pressure bulb operable to increase the pressure of the interior volume.

13. The apparatus as recited in claim 12, wherein said pressure bulb is operable to provide positive pressure to the interior of said container so as to force fluid disposed within the interior volume into the cut flower stalk.

14. The apparatus as recited in claim 13, and further including a pressure gauge, said pressure gauge operable to provide measurement of the pressure of the interior volume of the container.

15. A floral preservation apparatus operable to prolong the freshness of cut flowers disposed therein comprising:
a container, said container having at least one wall and a bottom integrally formed to create an interior volume, said container having an opening opposite said bottom, said at least one wall having an interior surface and an exterior surface, said container having an upper portion and a lower portion, said container being of sufficient height to receive and support a plurality of cut flowers, said container having a fluid disposed therein;
an insert, said insert having a contiguous wall forming an upper opening and a lower opening, said insert being of similar shape as the upper portion of said container, said insert having an upper edge and a lower edge, said insert operable to be frictionally engaged with the upper portion of said container, said insert further including a sealing collar, said sealing collar secured to said insert proximate said lower edge;
a sealing membrane, said sealing membrane being manufactured from a resilient material, said sealing membrane disposed across said upper opening of said insert, said sealing membrane hermetically sealed to the upper edge of the contiguous wall of said insert;
a plurality of nipples, said plurality of nipples integrally formed with said sealing membrane, said plurality of nipples extending downward into the interior volume of said container, and
wherein the plurality of nipples are operable to receive cut flower stalks therethrough and subsequently provide a hermetic seal therearound.

16. The floral preservation apparatus as recited in claim 15, wherein said plurality of nipples include a wall, said wall being contiguous, said wall defining a passage therethrough, said plurality of nipples having an upper opening and a lower opening on opposing ends of said passage, said wall being collapsible on itself in absence of a cut flower stalk being journaled through said passage.

17. The floral preservation apparatus as recited in claim 16, wherein said sealing collar is operable to engage the interior surface of said at least one wall in order to provide a hermetic seal therebetween.

18. The floral preservation apparatus as recited in claim 17, and further including a support grid, said support grid having an outer frame, said support grid having a plurality of cross members within said outer frame, said support grid operable to provide structural support for cut flower stalks.

19. The floral preservation apparatus as recited in claim 18, and further including a pressure bulb, said pressure bulb operably coupled to the interior volume of said container via a tube, said pressure bulb operable to increase the pressure of the interior volume, said pressure bulb is operable to provide positive pressure to the interior of said container so as to force fluid disposed within the interior volume into cut flower stalks mounted within said floral preservation apparatus.

20. The floral preservation apparatus as recited in claim 19, a pressure gauge, said pressure gauge operable to provide measurement of the pressure of the interior volume of the container.
